(19) United States
(12) Patent Application Publication
(10) Pub. No.: US 2020/0072316 A1
(43) Pub. Date: Mar. 5, 2020

(54) DEVICE FOR DAMPING TORSIONAL OSCILLATIONS

(71) Applicant: NANJING VALEO CLUTCH CO., LTD., Nanjing (CN)

(72) Inventors: Jonathan ROST, Nanjing (CN); Chunhui LIU, Nanjing (CN); Ke ZHANG, Nanjing (CN); Xing ZHAO, Nanjing (CN); David SALVADORII, Amiens (FR); Roel VERHOOG, Amiens (FR); Giovanni GRIECO, Amiens (FR); Antoine VIGREUX, Amiens (FR); Olivier FAFET, Amiens (FR); Matthieu MALLEY, Amiens (FR)

(73) Assignee: NANJING VALEO CLUTCH CO., LTD., Nanjing (CN)

(21) Appl. No.: 16/484,981

(22) PCT Filed: Feb. 11, 2018
(86) PCT No.: PCT/CN2018/076300

§ 371 Date: Aug. 9, 2019

(30) Foreign Application Priority Data
Feb. 10, 2017 (CN) 201710073126.5

(51) Int. Cl. F16F 15/14; F16F 15/129

(52) U.S. Cl. CPC F16F 15/145; F16F 15/30; F16F 15/129

(57) ABSTRACT

A device for damping torsional oscillations, the device including at least one support capable of rotational displacement around an axis, at least one pendulum assembly, including at least one pendulum mass, the pendulum assembly being movable with respect to the support, at least one rolling member, each rolling member interacting with at least one first raceway defined by the support and with at least one second raceway defined by the pendulum assembly, the displacement of the pendulum assembly with respect to the support being guided by at least one of those rolling members, the device further including at least one friction member, carried by the pendulum assembly, for generating hysteresis in all or parts of the relative displacements of the pendulum assembly and the support.

### TECHNICAL FIELD

The present invention relates to a device for damping torsional oscillations, in particular for a motor vehicle transmission system.

### BACKGROUND

In such an application the device for damping torsional oscillations may be integrated into a torsional damping system of a clutch capable of selectively connecting the combustion engine to the gearbox, in order to filter vibrations due to irregularities of the engine. Such a system is for instance a dual-mass flywheel.

As a variant, in such an application the device for damping torsional oscillations may be integrated into a friction disk of the clutch or into a hydrodynamic torque converter, or into a hybrid powertrain or associated with a flywheel rigidly connected to the crankshaft of the vehicle.

A device of this kind for damping torsional oscillations conventionally utilizes a support and one or more pendulum assemblies that are movable with respect to that support, the displacement of each pendulum assembly with respect to the support being guided by two rolling members each interacting on the one hand with raceways defined by the support, and on the other hand with raceways defined by the pendulum assemblies. Each pendulum assembly comprises, for example, two pendulum masses riveted to one another.

At low rotational speed, such devices are not centrifuged are so they are highly sensitive to the force of gravity, which may then cause undesired displacements of the pendulum assemblies and thus metallic noises due to impacts between said pendulum assemblies and the support.

In order to solve this problem it is known, for example from the application DE 10 2012 221 103, to provide springs between two circumferentially adjacent pendulum assemblies in such a way that the pendulum assemblies thus connected resist the force of gravity exerted on them in turn when a rotational motion is imparted to the device. Insertion of these springs involves configuring additional receptacles in the pendulum assemblies, or providing appropriate fastening means on those pendulum assemblies, which is costly and complex. In addition, insertion of the springs causes the appearance of an additional resonant frequency.

Insertion of the springs may also require the configuration of open cutouts in the support of the device, thus reducing deflection of the pendulum assemblies. It is furthermore necessary to dimension the springs correctly, and there is no guarantee that the springs' characteristics will be maintained over time.

### SUMMARY

An object of the invention is to reduce the influence of gravity on the pendulum assemblies, in particular at low rotational speed, while eliminating all or some of the disadvantages above.

The invention achieves this with the aid of a device for damping torsional oscillations, comprising:
at least one support capable of rotational displacement around an axis,
at least one pendulum assembly, comprising at least one pendulum mass, the pendulum assembly being movable with respect to the support,
at least one rolling member, each rolling member interacting with at least one first raceway defined by the support and with at least one second raceway defined by the pendulum assembly, the displacement of the pendulum assembly with respect to the support being guided by at least one of those rolling members,

the device comprising at least one friction member, carried by the pendulum assembly, for generating hysteresis in all or part of the relative displacements of the pendulum assembly and the support.

Impacts between the pendulum assembly and the support, in particular due to gravity, are consequently prevented. As the support rotates, the pendulum assembly successively occupies the highest position around the rotation axis of the support, and the presence of the friction member thus limits or slows the downward displacement of that pendulum assembly in response to gravity.

For purposes of the present application:
“axially” means “parallel to the rotation axis of the support”;
“radially” means “along an axis belonging to a plane orthogonal to the rotation axis of the support and intersecting that rotation axis of the support”;
“angularly” or “circumferentially” means “around the rotation axis of the support”;
“orthoradially” means “perpendicularly to a radial direction”.

The invention likewise relates to the above friction member considered in isolation.

The friction member may generate hysteresis regardless of the relative positions of the support and of said pendulum assembly.

The friction member may be axially arranged between the pendulum mass and the support. The friction member is thus axially between the pendulum mass assembly and the support meaning that the friction member may also have an interposition function to prevent axial impacts between the pendulum assembly and the support.

According to a first variant, the friction member is axially larger than the axial space between the pendulum mass and the support. The axial dimension may be the axial distance between two axial extremities. The friction member is thus compressed between the pendulum mass and the support.

In particular, the friction member may comprise a located and axial protuberance to be in contact with the support. This axial protuberance may be in a bubble shape. This axial protuberance may be made by entrapping air into the friction member during its fabrication.

Alternatively, the axial protuberance may have all shape that fit to generate hysteresis, such as a wave, such as a pin. Alternatively, the axial protuberance may also be an insert member fixed on the friction member. Several axial protuberances may be arranged on the friction member.

Alternatively or in combination, the friction member may comprise at least one thinned zone to locally camber the friction member to contact the support. The camber may be obtained by plastic deformation of the thinned zone. The friction member may comprise cuts, advantageously two cuts, extending from the contour of the friction member and nearing the one with respect to the other to define the thinned zone. The camber may be on a circumferential end region of the friction member.

Alternatively or in combination, the friction member may comprise at least one, located and axial bearing zone to be at least partially in contact with the rolling member. The bearing zone may have all shape that fit to generate hysteresis, such as a wave, such as a fold. Several bearing zones may be arranged on the friction member. The axial bearing zone makes it possible to generate hysteresis in all of the displacements of the rolling member(s).

The bearing zone may comprise a recess.

In particular, the bearing zone of the friction member may apply an axial stress at least on a lateral area of an axial face of the rolling member. The axial stress presses the rolling member against the opposite pendulum mass. The axial stress may be applied in a lateral area whose surface and location may vary depending on the position of the rolling member relative to the support and the pendulum masses. The order of magnitude of the axial stress may be comprised between 1 to 5N (Newton).

Alternatively or in combination, the friction member may comprise at least one locally folded zone to contact the rolling member. The friction member may comprise at least one thinned zone to locally fold the friction member to contact the rolling member. The folded zone may be obtained by plastic deformation of the thinned zone. The friction member may comprise a cut and fold, or plastic deformation, or camber, of the area between this cut and the contour of the friction member, alternatively two parallel cuts and a fold of the area between these two parallel cuts, preferably two series of two parallel cuts, offset circumferentially. The fold may be on a circumferential end region of the friction member.

The folded zone of the friction member may apply an axial stress only on a radially internal area of an axial face of the rolling member. The axial stress presses the rolling member against the opposite pendulum mass. The axial stress is generated as close as possible to the interacting zone between the rolling member and the raceway defined by the support. The axial stress may be applied in a radially internal area, with respect to the rolling member, extending over the first twenty percent of the diameter of the rolling member, preferably the first ten percent. The order of magnitude of the axial stress may be comprised between 1 to 5N (Newton).

According to a second variant, a progressivity member is axially arranged between the friction member and the pendulum mass to force the friction member into contact with the support. In this variant, the friction member is not compressed between the pendulum mass and the support but between the progressivity member and the support. Contrary to the first variant, the shape of the friction member does not permit to generate hysteresis but the additional part arranged between the pendulum mass and said friction member permit it.

The progressivity element permits to adapt a pendulum mass with an interposition member only used to prevent axial impacts between the pendulum assembly and the support into a friction member limiting or slowing the downward displacement of that pendulum assembly in response to gravity. The progressivity member may be a metal sheet comprising folds or waves for imparting elasticity to said progressivity member, for examples two folds. The folds may extend substantially radially between an inner and an outer periphery of the progressivity member. These folds may delimit several surfaces, oriented in different directions. In other cases, the progressivity member may be corrugated, entirely or locally.

The progressivity member may match the contour of the friction member so the progressivity and the friction member have the same general shape.

Alternatively, the progressivity member may comprise springs or elastomeric parts.

The progressivity member may be held on the support with a fastening region of the friction member onto the pendulum mass. The reciprocal axial action of the support on the friction member permits to maintain the progressivity member between the pendulum mass and the friction member. The fastening region prevents loosing the progressivity member during assembly step or during high speed acceleration of the support.

The friction member may comprise, in addition to its fastening region, an interposition region disposed axially between the pendulum mass and the support.

According to the first variant, the interposition region may be a flat surface from which extends the axial protuberance, the camber portion, the bearing zone or the folded zone. According to the second variant, the interposition region may be force into contact with the support. The interposition region may be locally offset from the pendulum mass by the progressivity member in order to contact the support.

The fastening region may pass through the progressivity member. The fastening region may comprise at least two fastening tabs and a reinforcement connecting those two tabs. The fastening region may extend between an end emerging from the interposition region and a free end, each fastening tab extending between these ends. The reinforcement may connect the tabs at their end emerging from the interposition region. The reinforcement may then allow the friction member, and eventually the progressivity member to be positioned appropriately on the pendulum mass, in particular to center the friction member on the pendulum mass.

Each fastening tab may comprise a hook for snap-locking the friction member onto the pendulum mass.

The friction member may comprise two types of fastening region comprising each one two tabs oriented in the same direction. The orientation of each type is different, advantageously perpendicular to each other. It permits a good immobilization of the friction member on the pendulum mass and fastening regions easy to make. The fastening regions may be located so that the friction member may be offset from the pendulum mass from 0.5 to 5 times the thickness of the friction member.

The progressivity member may comprise an opening that surrounds each fastening region. Alternatively, the progressivity member may comprise at least one connection region cooperating with the friction member or with the pendulum mass to avoid any relative movement between them. In particular, the progressivity member may cooperate with the fastening region of the friction member, for example by associating two cylindrical concentric projections from each member. Independently or in addition, the progressivity member may comprise at least one edge cooperating with an inner or an outer periphery of the pendulum mass to maintain radially the progressivity member.

Alternatively, the fastening region of the friction member may be an opening. Each friction member is rigidly coupled with one of pendulum masses by riveting or bolting passing through the opening. The friction member may be made of plastic. These materials are particularly well adapted as they are no abrasive for the metal of the support, as they maintain low wear characteristics and their friction coefficient with the metal is sufficient to prevent impact of the pendulum assembly in respect with the support.

Alternatively, the friction member may be made of metal. This metal sheet may comprise folds or waves for imparting elasticity to said friction member.

The friction member may be elastic. The elasticity of the friction member can absorb shocks.

According to a first embodiment of the invention, the device comprises one single support, and the pendulum assembly comprises a first and a second pendulum mass spaced axially with respect to one another, the first pendulum mass being arranged axially on a first side of the support and the second pendulum mass being arranged axially on a second side of the support, and

at least one member connecting the first and the second pendulum mass, pairing said masses,

the device comprises also two friction member, each being disposed axially between one of the pendulum mass and the support.

Alternatively, the device may comprise at least one friction member, this at least one friction member being disposed axially only between one of the pendulum mass and the support.

The device may comprise two distinct, circumferentially offset, friction members, each friction member being respectively in regard with one of the rolling member.

A connecting member of this kind is, for example, press-fitted via each of its axial ends into an opening configured in one of the pendulum masses. As a variant, the connecting member may be welded via its axial ends onto each pendulum mass. The connecting member may also be bolted or riveted onto each pendulum mass.

In a first variant of the first embodiment, the connecting member may define a first raceway for guiding the movement of the pendulum assembly relative to the support.

According to this first variant of the first embodiment, the pendulum assembly may comprise two connecting members pairing the first and the second pendulum mass, each connecting member defining a first raceway interacting respectively with one of the two rolling members guiding the displacement of that pendulum assembly with respect to the support. Each rolling member interacts here with a single raceway on the pendulum assembly side. A region of the periphery of that connecting member, for example a portion of the radially external surface of that connecting member, defines, for example, this raceway integral with the pendulum assembly. In this case the rolling member may also cooperate with another first raceway defined by the support, notably defined by a portion of the periphery of a window provided in the support, in which that connecting member is arranged.

According to this first variant of the first embodiment, each rolling member may then be stressed exclusively in compression between the raceway defined by the support and the raceway defined by the pendulum assembly, as mentioned above. These raceways interacting with a given rolling member may at least in part radially face each other, i.e. there exist planes, perpendicular to the rotation axis, in which both of those raceways extend.

According to this first variant of the first embodiment, the friction members may be arranged axially between the pendulum masses which carry them and the rolling members for all or parts of the relative positions of the pendulum assembly and the support. It permits to guide axially the rolling member movement and to prevent undesired axial impacts, especially when those elements are made of metal.

According to a second variant of the first embodiment, when there is still one support and when the pendulum assembly comprises two pendulum masses paired together, each rolling member may interact with two different raceways defined by the pendulum assembly, one of these raceways being defined by the first pendulum mass and the other of these raceways being defined by the second pendulum mass.

According to this second variant each connecting member is, for example, a rivet. The rivet may be received in a cavity of the support in which a rolling member is not already received. As before, a portion of the periphery of a window provided in the support may define a raceway of the support.

According to this second variant of the first embodiment, each rolling member may comprise, axially successively:
a region arranged in a cavity of the first pendulum mass and interacting with a raceway constituted by a portion of the periphery of that cavity;
a region arranged in a window of the support and interacting with a raceway constituted by a portion of the periphery of that window; and
a region arranged in a cavity of the second pendulum mass and interacting with a raceway constituted by a portion of the periphery of that cavity.

The device may be different from a device that comprises a single support. According to a second embodiment of the invention, the device comprises two distinct, axially offset, supports, the pendulum assembly is arranged axially between the two supports, each support defining a first raceway for interacting with the same rolling member,

In this second embodiment, the device may comprise two friction members, each being disposed axially between the pendulum mass and one support.

Alternatively, the device may comprise at least one friction member, this at least one friction member being disposed axially only between the pendulum mass and one of the support.

The device may comprise two distinct, circumferentially offset, friction members, each friction member being respectively in regard with one of the rolling member.

The pendulum assembly may comprise at least one pendulum mass, in particular a single pendulum mass or several pendulum masses that are preferably rigidly coupled, being preferably all arranged axially between the two supports. The pendulum mass(es) is (are) then sandwiched axially between the two supports. The two supports are, for example, rigidly coupled via a connection such as a rivet join, positioned radially internally with respect to the pendulum assemblies.

The shape of the raceways may be such that each pendulum assembly is displaced with respect to the support
both in translation around a notional axis parallel to the rotation axis of the support, and also
rotationally around the center of gravity of said pendulum assembly, such a motion also being called a “combined motion”.

As a variant, the shape of the aforementioned raceways may be such that each pendulum assembly is displaced with respect to the support only in translation around a notional axis parallel to the rotation axis of the support.

The invention also provides a dual mass flywheel comprising:
a primary flywheel for being fastened to a crankshaft,
a secondary flywheel connected to the primary flywheel by a plurality of elastic return members, and
the device for damping torsional oscillations as defined above, the support of said device being notably attached to the secondary flywheel.

The device for damping torsional oscillations may alternatively be part of a component for a transmission system of a motor vehicle that is not a dual mass flywheel. This component may be a hydrodynamic torque converter, or a friction clutch disk, or a dry or wet dual clutch or a wet single clutch or a flywheel integral with a crankshaft, or a component forming part of a hybrid drive train.

In all of the above, the device for damping torsional oscillations may be configured in such a way that the displacement of the pendulum assemblies allows filtering of the excitation order of the combustion engine of the vehicle into which the device is integrated, that combustion engine in particular having two or three or four cylinders.

In all of the above, the device may comprise, for example, a number of pendulum assemblies between two and eight, in particular three or six pendulum assemblies. All these pendulum assemblies may be circumferentially successive. The device for damping torsional oscillations may thus comprise a plurality of planes, perpendicular to the rotation axis, in each of which all the pendulum assemblies are arranged.

In all of the above, each support may be implemented as a single part, for example being entirely metallic.

In all of the above, the device may comprise:
at least one first pendulum assembly allowing a first order value of the torsional oscillations to be filtered, and
at least one second pendulum assembly allowing a second order value of the torsional oscillations, different from the first order value, to be filtered.

When the device for damping torsional oscillations is part of a component, the support of the device for damping torsional oscillations may then be one among:
a flange of the component;
a guide washer of the component;
a phase washer of the component; or
a support distinct from said web, said guide washer, and said phase washer. The invention also provides a vehicle drive train, comprising:
a combustion engine for vehicle propulsion, in particular having two, three, or four cylinders; and
a transmission system component as defined above.

### BRIEF DESCRIPTION OF THE DRAWINGS

A better understanding of the invention will be gained from reading the description below of non-limiting exemplifying embodiments thereof, and from an examination of the attached drawings, in which:

FIG. 1 depicts a dual mass flywheel comprising a device for damping torsional oscillations,

FIG. 2 shows partially an example of a device according to a first example of the first embodiment,

FIG. 3 shows partially an example of a device according to a first example of the first embodiment,

FIG. 4 shows partially an example of a device according to the second embodiment embodiment, and

FIGS. 5 and 6 show an example of friction member according to the first variant,

FIG. 7 shows another example of friction member according to the first variant,

FIGS. 8 and 9 show two devices with friction members according to the second variant,

FIGS. 10 and 11 show another example of friction member according to the first variant,

FIG. 12 shows partially an example of a device according to the first embodiment and comprising a friction member according to FIGS. 10 and 11,

FIG. 13 shows partially an example of a device according to the first embodiment and comprising a friction member according to FIG. 14,

FIG. 14 shows another example of friction member according to the first variant, and

FIGS. 15a and 15b show another example of friction member according to the first variant.

### DETAILED DESCRIPTION

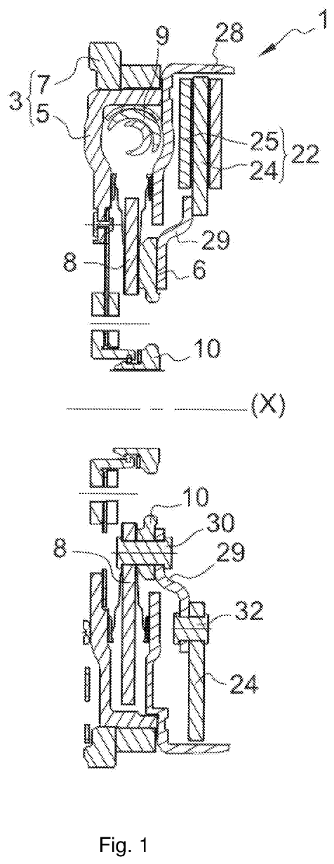

FIG. 1 shows a dual mass flywheel 1 that is part of a drive train of a vehicle. This drive train also comprises a combustion engine having two, three, or four cylinders.

The dual mass flywheel 1 comprises a primary flywheel 3 and a secondary flywheel 6 connected to the primary flywheel. This primary flywheel 3 comprises a flange 5 and a ring gear 7. This primary flywheel may be fastened to a crankshaft of the combustion engine.

The secondary flywheel 6 comprises a flange 8 that interacts with elastic return members 9. The elastic return members 9 are springs in the embodiment that is described. The springs 9 enable a rotational displacement of the secondary flywheel 6 relative to the primary flywheel 3 around an axis X.

FIG. 1 shows that the flange 8 is riveted onto a hub 10 of the secondary flywheel 6. The hub 10 has splines that enable it to be fitted onto a shaft.

The dual mass flywheel 1 comprises a device 22 for damping torsional oscillations that is of pendulum type.

This device 22 comprises a support 24 that is in the example described riveted onto a linking plate 29 by rivets 32, said linking plate 29 being riveted to the hub 10 and to the flange 8 via rivets 30.

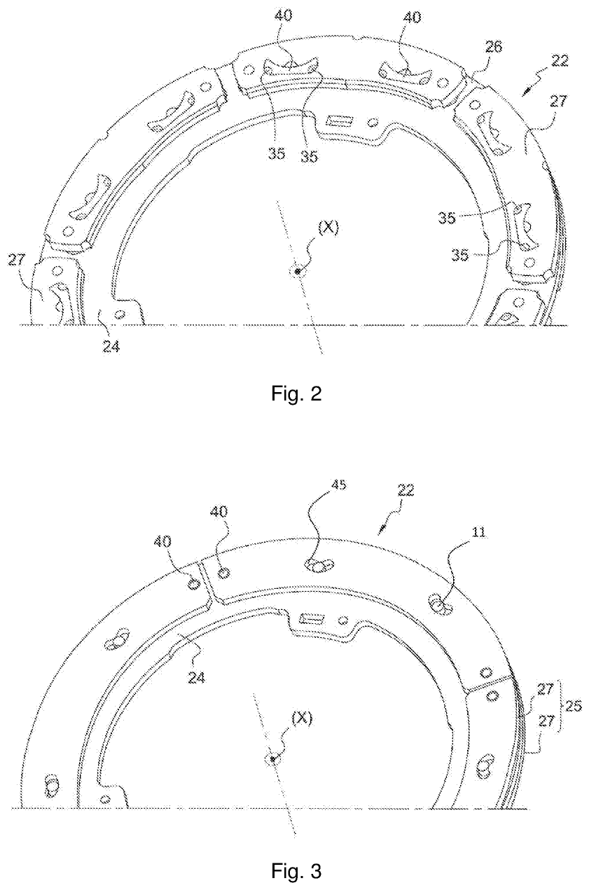

The device further comprises pendulum assemblies 25. Three different examples of a device 22 for damping torsional oscillations are now going to be described in reference to FIGS. 2, 3 and 4. These three devices may be integrated in the dual mass flywheel of FIG. 1.

In FIG. 2, the device 22 is in a neutral position, i.e. it is not filtering the torsional oscillations transmitted by the drive train due to irregularities of the combustion engine.

In the example considered, six pendulum assemblies 25 are provided, being distributed uniformly around the periphery of axis X.

In the example considered, support 24 is globally in the shape of a ring having two opposite sides 26 that here are planar faces.

As shown on FIG. 2, in the example considered each pendulum assembly 25 comprises:
two pendulum masses 27, each pendulum mass 27, extending axially facing one side 26 of support 24; and
two connecting members 40 rigidly coupling the two pendulum masses 27.

In the example considered, connecting members 40 of a same pendular assembly 25, also called “spacers,” are angularly offset. Each assembly 25 extends angularly between two circumferential ends that correspond respectively to circumferential ends of pendulum masses 27 of that assembly.

In the example of FIG. 2, each connecting member 40 is press-fitted into an opening configured in one of pendulum masses 27 of pendulum assembly 25 in order to rigidly couple those two pendulum masses 27 with one another.

In yet another alternative, each end of a connecting member 40 is rigidly coupled with one of pendulum masses 27 by welding or riveting or bolting.

The device 22 for damping torsional oscillations further comprises rolling members guiding the displacement of pendulum assemblies with respect to support 24. Rolling members here are rollers.

In the example described, the motion of each pendulum assembly 25 with respect to support 24 is guided by two rolling members. This motion is, for example, a combined motion.

Each rolling member is received in a window configured in support 24. Each window has a continuous periphery, and a portion of that periphery defines a first raceway, integral with support 24, on which one of rolling members received in that window will roll.

In the example of FIG. 2, each window furthermore receives a connecting member 40 of a pendulum assembly 25. Each connecting member 40 defines a second raceway that is integral with pendulum assembly 25 to which that connecting member 40 belongs and on which one of rolling members rolls in order to guide the displacement of that pendulum assembly 25 with respect to support 24. The second raceway is for instance defined by a region of the radially external surface of said connecting member 40.

The device 22 of FIG. 2 further comprises abutment damping members 35, for damping impacts associated with the pendulum assembly 25 coming into abutment against the support 24. In the example of FIG. 2, each connecting member 40 is associated with such an abutment damping member 35. The abutment damping member 35 is for instance configured in order to be compressed between an edge of the window that receives a rolling member and between a radially internal edge of the connecting member 40.

This abutment damping member comprises axial protrusions that are accommodated inside holes arranges inside the pendulum masses. Each protrusion enables the abutment damping member to be attached to a pendulum mass 27.

FIG. 3 shows a device 22 of another variant. This device 22 still comprises a single support 24 and several pendulum assemblies 25, each pendulum assembly 25 still comprising two pendulum masses 27 rigidly coupled.

Contrary to what was described in reference to FIG. 2, each window 45 arranged in the support 24 does not accommodate a rolling member and a connecting member 40. Each connecting member 40, which is a rivet in this case, is accommodated in a cavity that does not accommodate any rolling member.

In the example of FIG. 3, each rolling member 11 comprises, axially successively:
a region arranged in a cavity of the first pendulum mass 27 and interacting with a second raceway constituted by a portion of the periphery of that cavity;
a region arranged in a window 45 of the support 24 and interacting with a first raceway constituted by a portion of the periphery of that window; and
a region arranged in a cavity of the second pendulum mass 27 and interacting with a second raceway constituted by a portion of the periphery of that cavity.

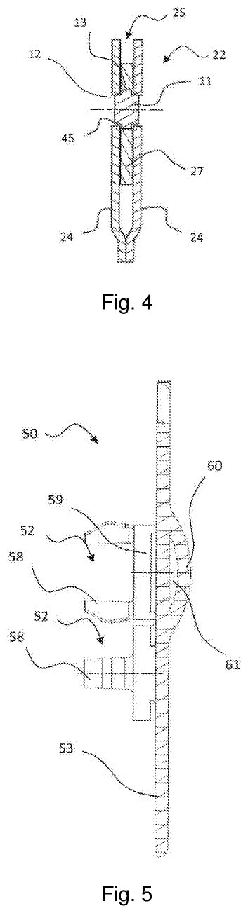

FIG. 4 shows a device 22 of another embodiment. Contrary to the FIGS. 2 and 3, the device 22 comprises two distinct 24, axially offset, supports, the pendulum assemblies 25 are arranged axially between the two supports 24, each support defining a first raceway 13 for interacting with the same rolling member,

In this example, each pendulum assemblies 25 may comprise one single pendulum mass 27 arranged axially between the two supports 24. The pendulum mass(es) is (are) then sandwiched axially between the two supports. The two supports 24 are, for example, rigidly coupled via a connection such as a rivet join, positioned radially internally with respect to the pendulum assemblies 25.

In the example of FIG. 4, each rolling member 11 comprises, axially successively:
a region arranged in a window 45 of the first support 24 and interacting with a first raceway 12 constituted by a portion of the periphery of that window;
a region arranged in a cavity of the pendulum mass 27 and interacting with a second raceway 13 constituted by a portion of the periphery of that cavity; and
a region arranged in a window 45 of the second support 24 and interacting with a first raceway constituted by a portion of the periphery of that window.

In the example of FIG. 12, each rolling member 11 comprises, axially successively:
a region arranged in a window of the support 24 and interacting with a first raceway constituted by a portion of the periphery of that window and with a second raceway constituted by a portion of the connecting member 40, this region presents a first face 120 in regard to a first pendulum mass 27 and interacting with a friction member 50, and a second face 121, opposed; and
a region, or pin 111, extended from the second face, arranged in a window of the second pendulum mass 27 and interacting with a first raceway constituted by a portion of the periphery of that window.

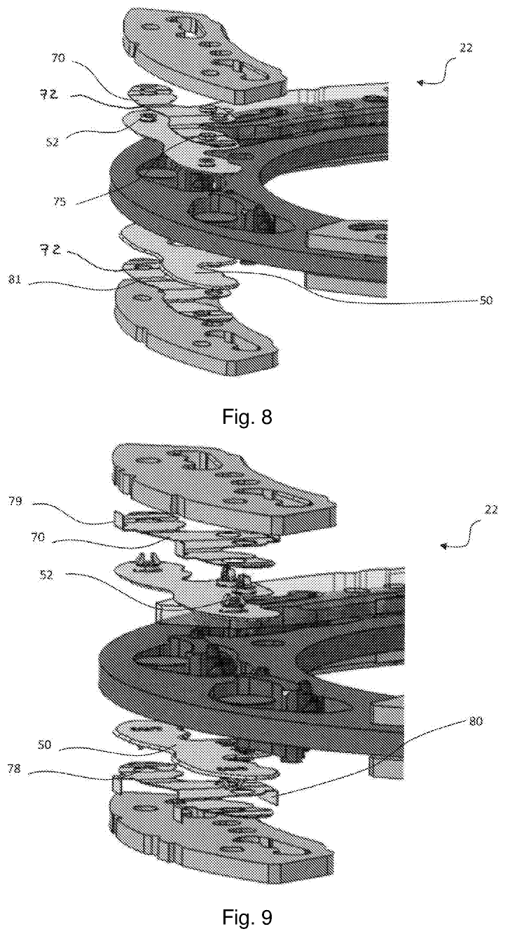

FIGS. 5 to 15b show different examples according to five different variants of friction member 50 that may be carried by each of the pendulum mass 27 that has been described on FIG. 1 on 4. In particular, there is at least one friction member 50 between the pendulum mass 27 or one of the pendulum mass 27 and one of the supports 24 or the support 24, respectively. For example, there are friction members 50 between each pendulum mass 27 and the support(s) 24 as shown on FIGS. 8 and 9.

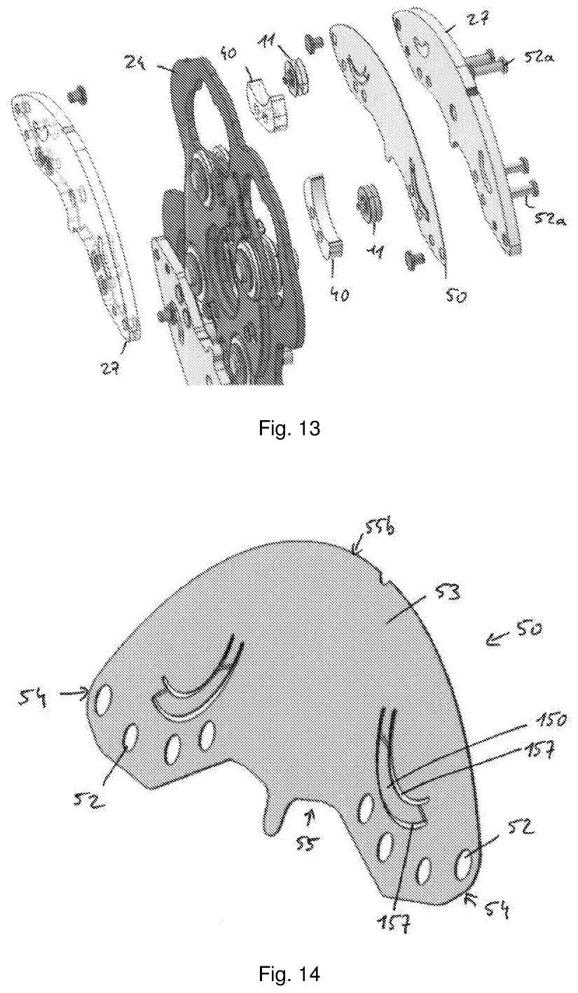

One of the pendulum mass 27 of a pendulum assembly 25 may carry at least one friction member 50 on the side in regard with the support 24. In the embodiment of the FIG. 4, each pendulum mass 27 may carry two friction members 50 on each side, in FIG. 12, only one pendulum mass 27 of each pendulum assembly 25 may carry two friction members 50 on the side in regard with the support 24 and in FIG. 13, only one pendulum mass 27 of each pendulum assembly 25 may carry one friction member 50 on the side in regard with the support 24.

In all examples, the friction member 50 generates hysteresis in all the relative displacements of the pendulum assembly 25 and the support 24 and regardless of the relative positions of said support 24 and of said pendulum assemblies 25.

Impacts between the pendulum assemblies 25 and the support 24, in particular due to gravity, are consequently prevented. As the support 24 rotates, the pendulum assemblies 25 successively occupy the highest position around the rotation axis of the support, and the presence of the friction member 50 thus limits or slows the downward displacement of that pendulum assembly in response to gravity.

The friction members 50 may be made in particular of a damping material such as plastic. Alternatively, the friction members 50 may be made in an elastic metal.

In all examples, the friction members 50 are axially arranged between one the pendulum mass 27 and the support 24. The friction members 50 are thus axially between the pendulum mass assembly and the support meaning that means the friction member may also have an interposition function to prevent axial impacts between the pendulum assembly and the support.

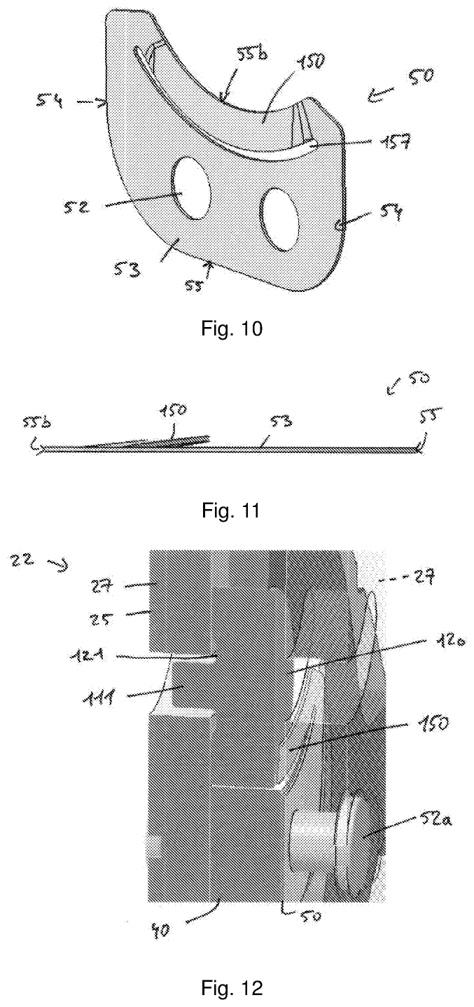

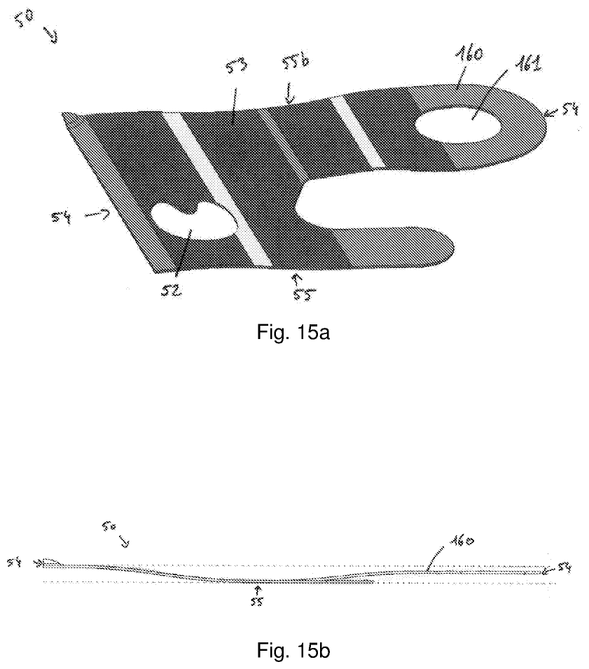

In all examples described, each friction member 50 comprises at least one fastening region 52 on the pendulum mass 27 and an interposition region 53 disposed axially between the pendulum mass 27 and the support 24. For example, in FIGS. 5 to 9, each friction member 50 comprises four fastening regions 52, in FIGS. 10 to 12, each friction member 50 comprises two fastening regions 52, in FIGS. 13 and 14, each friction member 50 comprises eight fastening regions 52 and in FIGS. 15a and 15b, each friction member 50 comprises one fastening region 52.

The interposition region 53 extends between two circumferential ends 54 radially outside the connecting members. The interposition region comprises also a radially inner end 55 circumferrially between the ends 54. The interposition region comprises also a radially upper end 55b circumferrially between the ends 54.

For example, each fastening region 52 may comprise two fastening tabs 58 and a reinforcement 59 connecting those two tabs. The fastening regions 52 extend between an end emerging from the interposition region 53 and a free end, each fastening tab 58 extending between these ends. The reinforcement 59 connects the tabs 58 at their end emerging from the interposition region 53.

Each fastening tab 58 comprises a hook for snap-locking the friction member 50 onto the pendulum mass 27.

In the example described on FIG. 5 and on one part and on FIG. 9 on the other part, the friction member 50 comprises two types of fastening region comprising each one two tabs 58 oriented in the same direction. The orientation of each type is perpendicular to each other. The radially inner end 55 comprises 2 fastening region 52 of on first type as the each circumferential end 54 comprises on fastening region 52 of the other type.

Alternatively, each fastening region 52 may comprise an opening. Each friction member 50 is rigidly coupled with at least one of pendulum masses 27 by riveting 52a or bolting passing through the opening.

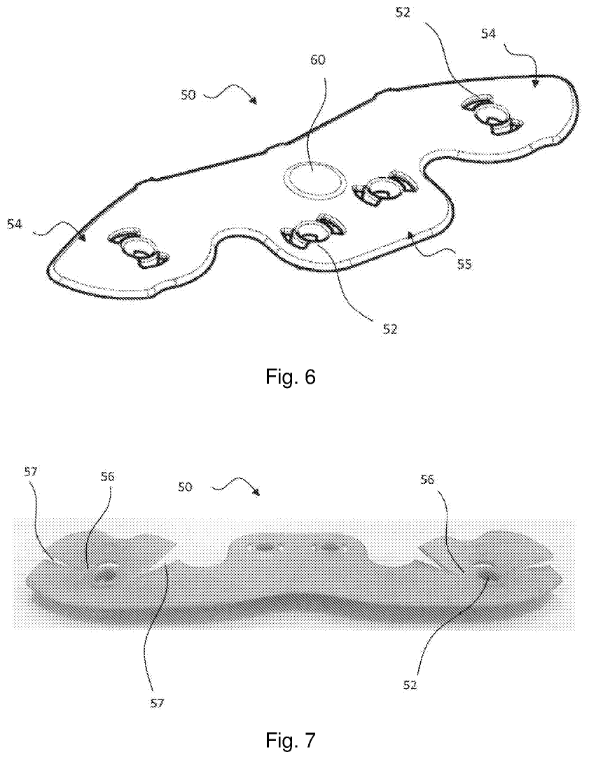

In the example described on FIGS. 5 and 6 on one part and on FIGS. 7, 10, 11, 14, 16a and 16b on the other part, the friction member 50 is axially larger than the axial space between the pendulum mass 27 and the support 24.

In the example described on FIGS. 5 and 6, the friction member 50 comprises a located and axial protuberance 60 to be in contact with the support 24. The interposition region 53 is a flat surface from which extends the axial protuberance 60. This axial protuberance 60 has a bubble shape. This axial protuberance may be made by entrapping air in a cavity 61 of friction member during its fabrication.

In the example described, this axial protuberance 60 is located on the friction member between the circumferential ends 54 and radially outside the radially inner end 55. This axial protuberance is located to be always in contact of the support regardless of the relative positions of the support 24 and of the pendulum assembly 25.

In the example described on FIG. 7, the friction member 50 comprises two thinned zone 56 to locally camber the friction member to contact the support. The camber is obtained by plastic deformation of the thinned zones 56. The cambers are on each circumferential end region 54 of the friction member. The friction member 50 comprises cuts 57, two cuts per thinned zones, extending from the contour of the friction member 50 and nearing the one with respect to the other to define the thinned zone. In this example, the cuts of each thinned zone are converging at one of the fastening region 52. The cuts 57 of each thinned zone are on both sides of this fastening region 52.

In the example described on FIGS. 10 and 11, the friction member 50 may comprise at least one thinned zone 56 to locally fold the friction member 50 to contact the rolling member 11. Alternatively, or complementarily, the friction member 50 may comprise at least one cut 157. The at least one cut 157 may extend near to the upper end 55b in the interposition region 53. The cut 157 may be adapted to locally fold the friction member 50 to contact the rolling member 11. The fold is obtained by plastic deformation of the thinned zone 56 and/or the zone near the cut 157. The fold is on the upper end 55b region of the friction member. The folded zone 150 may be located between the cut 157 and the upper end 55b and the folded zone 150 is axially offset relative to the interposition region 53 of the friction member 50 to be in contact with the rolling member 11.

In the example described on FIG. 14, the friction member 50 may comprise two thinned zones 56 to locally fold the friction member 50 to contact the rolling member 11. Alternatively, or complementarily, the friction member 50 may comprise four cuts 157, parallel two by two. Preferably, the two series of two parallel cuts are circumferentially offset. A series of two parallel cuts 157 may be on each circumferential end region 54. The interposition region 53 between two cuts 157 of a series of parallel cuts 157 may be fold to contact the rolling member 11. The fold zone 150 is obtained by plastic deformation of the thinned zone 56 and/or the zone between two cuts 157 of a series of parallel cuts 157. The fold zone 150 is on the inner end 55 region of the friction member 50. The folded zone 150 may be axially offset relative to the interposition region 53 of the friction member 50 to be in contact with the rolling member 11. Each folded zone 150 of the friction member 50 may apply an axial stress only on a radially internal area of a first axial face of the rolling member 11 which is in regard of the friction member 50. The axial stress presses the rolling member 11 against the opposite pendulum mass 27. The axial stress is generated as close as possible to the interacting zone between the rolling member 11 and the raceway defined by the support 24. The axial stress may be applied in a radially internal area, with respect to the rolling member 11, extending over the first twenty percent of the diameter of the rolling member 11, preferably the first ten percent. The order of magnitude of the axial stress may be comprised between 1 to 5N (Newton).

In the example described on FIGS. 15a and 15b, the friction member 50 may comprise one bearing zone 160 to contact at least partially the rolling member 11. The bearing zone 160 may comprise a recess 161. Preferably, the bearing zone 160 may be on one of the circumferential end region 54. The bearing zone 160 may be obtained by plastic deformation. The bearing zone 160 may be axially offset relative to the interposition region 53 of the friction member 50 to be in contact with the rolling member 11.

In particular, the bearing zone 160 of the friction member 50 may apply an axial stress at least on a lateral area of the axial face of the rolling member. The lateral area may be a portion of the first axial face of the rolling member 11 which is in regard of the friction member 50. The axial stress presses the rolling member 11 against the opposite pendulum mass 27. The axial stress may be applied in a lateral area whose surface and location may vary depending on the position of the rolling member 11 relative to the support 24 and the pendulum masses 27. The order of magnitude of the axial stress may be comprised between 1 to 5N (Newton).

In the examples described on FIGS. 8 and 9, for each pendulum assembly, a progressivity member 70 is axially arranged between one friction member 50 and each pendulum mass 27 to force the interposition region 53 is force into contact with the support 24. The fastening regions 52 pass through the progressivity members 70. The interposition region 53 is locally offset from the pendulum mass 27 by the progressivity member 70 in order to contact the support 24. The progressivity members 70 may be a metal sheet and comprises folds 72 for imparting elasticity. The folds 72 extend substantially radially between an inner and an outer periphery of the progressivity member 70. These folds delimit several surfaces, oriented in different directions, to impart elasticity to said progressivity member.

The progressivity members 70 match the contour of the friction member 50.

The progressivity members 70 are held on the support 24 with the fastening region 52 of the friction members.

In the example describe on FIG. 8, the friction members 50 are not snap-locked on the pendulum masses 27. The fastening regions 52 are mounted without play on the pendulum mass 27. The fastening regions 52 are cylindrical projections cooperating with holes of the pendulum masses 27. The progressivity members 70 comprise cylindrical projections 75, each surrounding concentric projection of said friction members 50.

In the example described FIG. 9, the progressivity members 70 comprise openings 78 that surround each fastening region 52 as described in reference to FIGS. 5 and 6. The progressivity members 70 comprise also two outer edges 79 cooperating with an outer periphery of the pendulum mass 27 and an inner edge 80 cooperating with an outer periphery of the pendulum mass 27 to maintain radially the progressivity member.

The invention is not restricted to what has been described above.

In other non described examples, the device 22 for damping torsional oscillations may be integrated into a component of a transmission system that is not a dual mass flywheel, that component being, for example a hydrodynamic torque converter, or a friction clutch disk or a dry or wet dual clutch or a wet single clutch or a flywheel integral with a crankshaft, or a component forming part of a hybrid drive train.

In known fashion, such a component may comprise a torsional damper exhibiting at least one input element, at least one output element, and circumferentially acting elastic return members that are interposed between said input and output elements, the terms “input” and “output” being defined with respect to the direction of torque transmission from the combustion engine of the vehicle toward the latter's wheels. The support 24 of the device 22 may then be constituted by:
an input element of the torsional damper;
an output element or an intermediate phasing element arranged between two series of springs of the damper; or
an element rotationally connected to one of the aforementioned elements and distinct therefrom, being then, for example, a support specific to device 22.

1. A device for damping torsional oscillations, the device comprising:
at least one support capable of rotational displacement around an axis,
at least one pendulum assembly, comprising at least one pendulum mass, the pendulum assembly being movable with respect to the support,
at least one rolling member, each rolling member interacting with at least one first raceway defined by the support and with at least one second raceway defined by the pendulum assembly, the displacement of the pendulum assembly with respect to the support being guided by at least one of those rolling members
the device comprising at least one friction member, carried by the pendulum assembly, for generating hysteresis in all or parts of the relative displacements of the pendulum assembly and the support.

2. The device of claim 1, the friction member generating hysteresis regardless of the relative positions of the support and of said pendulum assembly.

3. The device of claim 1, the friction member being axially arranged between the pendulum mass and the support.

4. The device of claim 3, further comprising a progressivity member axially arranged between the friction member and the pendulum mass to force the friction member into contact with the support or at least one of the rolling members.

5. The device of claim 4, the progressivity member being a metal sheet comprising folds or waves for imparting elasticity to said progressivity member.

6. The device of claim 4, the progressivity member being held on the support or at least one of the rolling members with a fastening region of the friction member onto the pendulum mass.

7. The device of claim 1, the friction member being axially larger than the axial space between the pendulum mass and the support.

8. The device of claim 7, the friction member comprising a located and axial protuberance to be in contact with the support.

9. The device of claim 7, the friction member comprising at least one thinned zone to locally camber said friction member to contact the support.

10. The device of claim 7, the friction member comprising at least one, located and axial bearing zone to be at least partially in contact with the rolling member.

11. The device of claim 10, the bearing zone comprising a recess.

12. The device of claim 10, the bearing zone of the friction member applying an axial stress at least on a lateral area of an axial face of the rolling members.

13. The device of claim 7, the friction member comprising at least one locally folded zone to contact the rolling member.

14. The device of claim 13, the folded zone of the friction member applying an axial stress only on a radially internal area of an axial face of the rolling members.

15.-16. (canceled)

17. The device of claim 1, comprising one single support, and the pendulum assembly comprising a first and a second pendulum mass spaced axially with respect to one another, the first pendulum mass being arranged axially on a first side of the support and the second pendulum mass being arranged axially on a second side of the support, and
at least one member connecting the first and the second pendulum mass, pairing said masses,
the device comprising two friction member, each being disposed axially between one of the pendulum mass and the support.

18. The device of claim 1, comprising two distinct, axially offset, supports, each pendulum assembly comprising at least one pendulum mass arranged axially between the two supports, each support defining a first raceway for interacting with the same rolling member,
the device comprising two friction members, each being disposed axially between the pendulum mass and the support.

19. The device of claim 1, comprising two distinct, axially offset, supports, each pendulum assembly comprising at least one pendulum mass arranged axially between the two supports, each support defining a first raceway for interacting with the same rolling member,
the device comprising at least one friction members, this at least one friction member being disposed axially only between the pendulum mass and one of the support.

20. The device of claim 1, comprising one single support, and the pendulum assembly comprising a first and a second pendulum mass spaced axially with respect to one another, the first pendulum mass being arranged axially on a first side of the support and the second pendulum mass being arranged axially on a second side of the support, and
at least one member connecting the first and the second pendulum mass, pairing said masses,
the device comprising at least one friction member, this at least one friction member being disposed axially only between one of the pendulum mass and the support.

21. The device of claim 19, the device comprising two distinct, circumferentially offset, friction members, each friction member being respectively in regard with one of the rolling members.

22. A dual mass flywheel, comprising:
a primary flywheel for being fastened to a crankshaft,
a secondary flywheel connected to the primary flywheel by a plurality of elastic return members, and
the device of claim 1, the support of said device being notably attached to the secondary flywheel.
